(19) United States
(12) Patent Application Publication
(10) Pub. No.: US 2008/0028027 A1
(43) Pub. Date: Jan. 31, 2008

(54) Multi-threaded instant messaging

(76) Inventor: Jack Jachner, Lexington, MA (US)

Correspondence Address: ALCATEL LUCENT;INTELLECTUAL PROPERTY & STANDARDS, 3400 W. PLANO PARKWAY, MS LEGL2, PLANO, TX, 75075, US

(21) Appl. No.: 11/492,621

(22) Filed: Jul. 25, 2006

(51) Int. Cl. G06F 15/16

(52) U.S. Cl. 709/206; 709/207

(57) ABSTRACT

Multi-threaded instant messaging is accomplished by including, within an instant message device, an instant message client capable of managing multiple instant message threads, in which each of the instant message threads identifies at least one instant message in a stream of instant messages transmitted during an instant message communication session. Upon receiving a current instant message during the instant message communication session, the instant message client extracts a thread indicator from the current instant message and uses the thread indicator to identify the instant message thread associated with the current instant message. The instant message client further displays the stream of instant messages on a display of the instant message device such that the current instant message is visually associated with its instant message thread.

### BACKGROUND OF THE INVENTION

1. Technical Field of the Invention

The present invention relates in general to communication systems, and in particular, to an instant messaging communication system for transmitting instant messages.

2. Description of Related Art

Instant messaging communication systems deliver electronic text messages instantly from message senders to message recipients. For example, a text-based instant message usually appears in a pop-up window on the message recipient's computer screen essentially as soon as the message sender clicks the send button, subject to any propagation delays in the underlying transport network. Therefore, a message recipient is able to view the instant message without requiring the recipient to access an e-mail program or otherwise check for messages.

In a typical scenario, a first user (User A) initiates an instant message communication session with a second user (User B) by clicking on a “Send Instant Message” button or other similar button on User A's computer screen and identifying the message recipient (User B) for the instant message. For example, User A may access a “Buddy List” to determine if User B is on-line and available to receive instant messages, and then click on a “Send Instant Message” button for User B. An instant message pop-up window then appears on User A's computer screen to allow User A to type a message to User B. When User A is finished typing the message, User A can click a “Send” button, press “Enter” or otherwise initiate transmission of the instant message to User B. When the instant message is received at User B's computer, a similar pop-window appears on User B's computer screen that includes the text message typed by User A. After User B types a response instant message to User A and clicks “Send,” the response instant message appears underneath the first instant message sent by User A in the pop-up windows on the computer screens of both User A and User B.

Thus, existing instant message applications display instant messages in chronological order of reception time and/or send time. Such message display sequencing may be unsatisfactory for a two-party instant message exchange in which User A receives an instant message from User B while User A is typing a response to a specific previously received instant message from User B. In addition, chronological message display may also be unsatisfactory in multi-party instant message exchanges. For example, problems may occur if User A is composing a response in reply to a User B instant message, while other instant messages from other participants (User C) are received. In such situations, the context of the response generated by User A to User B's instant message may be obscured by the arrival of the instant message from User C.

Since composing (typing or otherwise entering) a response to an instant message takes time, in either two-party or multi-party exchanges, the context of the response may be lost by the arrival of newer instant messages. Thus, many instant message users find it difficult to keep track of the association between instant messages. Therefore, what is needed is an instant messaging communication system capable of maintaining associations between instant messages and responses thereto.

### SUMMARY OF THE INVENTION

Embodiments of the present invention provide an instant message device that includes an instant message client, a processor and a display. The instant message client is capable of managing multiple instant message threads, in which each of the instant message threads identifies at least one instant message in a stream of instant messages transmitted during an instant message communication session between a first user operating the instant message device and at least one additional user. The processor executes the instant message client to initiate the instant message communication session and to process a current instant message received from the additional user during the instant message communication session. The current instant message includes a thread indicator identifying one of the instant message threads as an identified instant message thread. The display is coupled to the processor to display the stream of instant messages such that the current instant message is visually associated with the identified instant message thread.

In one embodiment, each of the instant messages in the stream of instant messages has a respective message identifier associated therewith, and the thread indicator includes one of the message identifiers. In another embodiment, the thread indicator includes a timestamp indicating a start time at which the additional user commenced composing the current instant message. The processor is operable to identify one of the instant messages displayed on the display immediately prior to the timestamp as the identified instant message thread.

In a further embodiment, the instant message device further includes a graphical user interface coupled between the processor and the display for displaying the instant messages on the display. The graphical user interface is further operable to enable the first user to generate a response instant message in response to a select one of the instant messages in the stream of instant messages. The processor is operable to identify a select one of the instant message threads associated with the select instant message and to include an additional thread indicator identifying the select instant message thread within the response instant message.

Embodiments of the present invention further provide an instant messaging communication system including an instant message device, an instant message server and a communication network. The instant message device includes an instant message client capable of managing multiple instant message threads, in which each of the instant message threads identifies at least one instant message in a stream of instant messages transmitted during an instant message communication session and each of the instant message threads is identified by a respective thread indicator included in the instant messages. The instant message device further includes a display for displaying the stream of instant messages to visually associate the instant messages with their respective instant message threads. The instant message server is associated with the instant message device to transmit and receive the instant messages to and from the instant message device. The communication network transmits the instant messages between the instant message device and the instant message server.

Embodiments of the present invention additionally provide a method for facilitating multi-threaded instant messaging, including the steps of initiating an instant message communication session, receiving a current instant message during the instant message communication session, in which the current instant message includes a thread indicator and identifying an instant message thread associated with the current instant message from the thread indicator. The instant message thread identifies at least one instant message in a stream of instant messages transmitted during the instant message communication session. The method further includes the step of displaying the current instant message such that the current instant message is visually associated with the instant message thread.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary instant message device for use with embodiments of the present invention;

FIG. 2 illustrates an exemplary instant messaging communication system for use with embodiments of the present invention;

FIG. 3 is a message flow diagram illustrating an exemplary two-party instant message exchange, in accordance with embodiments of the present invention;

FIG. 4A illustrates an exemplary prior art display of the instant message exchange of FIG. 3;

FIG. 4B illustrates an exemplary display of the instant message exchange of FIG. 3 in accordance with embodiments of the present invention;

FIG. 5 is a message flow diagram illustrating an exemplary multi-party instant message exchange, in accordance with embodiments of the present invention;

FIG. 6A illustrates an exemplary prior art display of the instant message exchange of FIG. 5;

FIG. 6B illustrates an exemplary display of the instant message exchange of FIG. 5 in accordance with embodiments of the present invention;

FIG. 7 illustrates an exemplary format of an instant message, in accordance with embodiments of the present invention;

FIG. 8 is a flowchart illustrating an exemplary process for facilitating multi-threaded instant message streams, in accordance with embodiments of the present invention;

FIG. 9 is a flowchart illustrating another exemplary process for facilitating multi-threaded instant message streams, in accordance with embodiments of the present invention; and

FIG. 10 is a flowchart illustrating yet another exemplary process for facilitating multi-threaded instant message streams, in accordance with embodiments of the present invention.

### DETAILED DESCRIPTION OF THE DRAWINGS

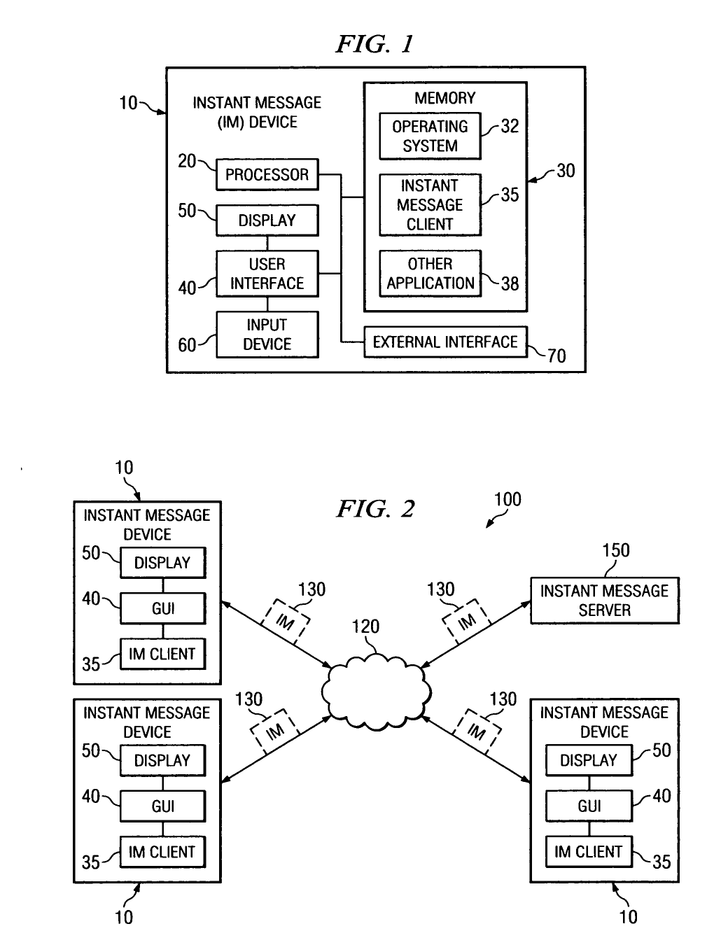

FIG. 1 illustrates an exemplary instant message device 10 for use with embodiments of the present invention. The instant message device 10 is a user-operated physical communications device capable of instantly sending and/or receiving electronic text message communications over a communications network. Examples of such instant message devices 10 include, but are not limited to, a laptop computer, a personal computer, a desktop phone, a cell phone, a personal digital assistant (PDA) or other user-operated communication device.

In general, the instant message device 10 includes a processor 20, memory 30, user interface 40, display 50, input device 60 and external interface 70. The processor 20 includes one or more processors that execute instructions (e.g., applications) and the memory 30 includes one or more memories that store instructions (e.g., applications) and data used by the processor 20. As used herein, the term “processor” is generally understood to be a device that drives a general-purpose computer. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein.

For example, within the memory 30 is shown an operating system 32, an instant message client 35 (e.g., an instant message application or software program) and other applications 38 that include instructions executable by the processor 20. To transmit and/or receive instant messages, the processor 20 accesses and runs the instant message client 35 within the memory 30. During execution of the instant message client 35, the instant message client 35 is operable to generate and transmit a text-based instant message via the processor 20. For example, the instant message client 35 can communicate with the input device 60 via the processor 20 and user interface 40 to generate an outgoing instant message and communicate with the external interface 70 via the processor 20 to transmit the outgoing instant message over a communications network. In addition, the instant message client 35 is operable to receive and display incoming instant messages via the processor 20. For example, the instant message client 35 can communicate with the external interface 70 via the processor 20 to receive an incoming instant message and communicate with the display 50 via the processor 20 and user interface 40 to display the received instant message.

In accordance with embodiments of the present invention, the instant message client 35 is further capable of managing multiple instant message threads, in which each of the instant message threads identifies at least one instant message in a stream of instant messages transmitted during an instant message communication session between a user operating the instant message device 10 and at least one additional user. Once the processor 20 executes the instant message client 35 to initiate the instant message communication session, each new incoming instant message is processed by the processor 20 to associate that new incoming instant message with one of the instant message threads.

For example, in one embodiment, the new incoming instant message includes a thread indicator identifying one of the instant message threads as the associated instant message thread. The processor 20 extracts the thread indicator from the new incoming instant message, and communicates with the instant message client 35 to identify the associated instant message thread and display the new incoming instant message on the display 50 such that the new incoming instant message is visually associated with the identified instant message thread. For example, the new incoming instant message may be displayed directly underneath the last instant message in the associated instant message thread regardless of the number of instant messages received in between. As another example, the new incoming instant message may be displayed in a separate window associated with that instant message thread. As a further example, the new incoming instant message, along with other instant messages associated with the same instant message thread may be displayed as bold-face, italicized or other type-face to indicate their association. As still a further example, the new incoming instant message may be displayed with reference to a particular previous instant message in the instant message thread (e.g., “In response to the message beginning with . . . .”).

In addition, the processor 20 processes each new outgoing instant message generated by the user to associate the new outgoing instant message with one of the instant message threads. For example, in one embodiment, the instant message client 35 enables the user to generate a response instant message in response to one of the previous instant messages in the instant message stream (e.g., either a previous outgoing instant message previously generated by the user or one of the incoming instant messages generated by another user involved in the instant message communication session). The instant message client 35 determines which previous instant message that the user is responding to based on input from the user via the input device 60 and user interface 40. For example, the user can either click on the previous instant message on the display 50 to which the user is responding or immediately begin typing a response to the last received instant message before any other instant messages are received.

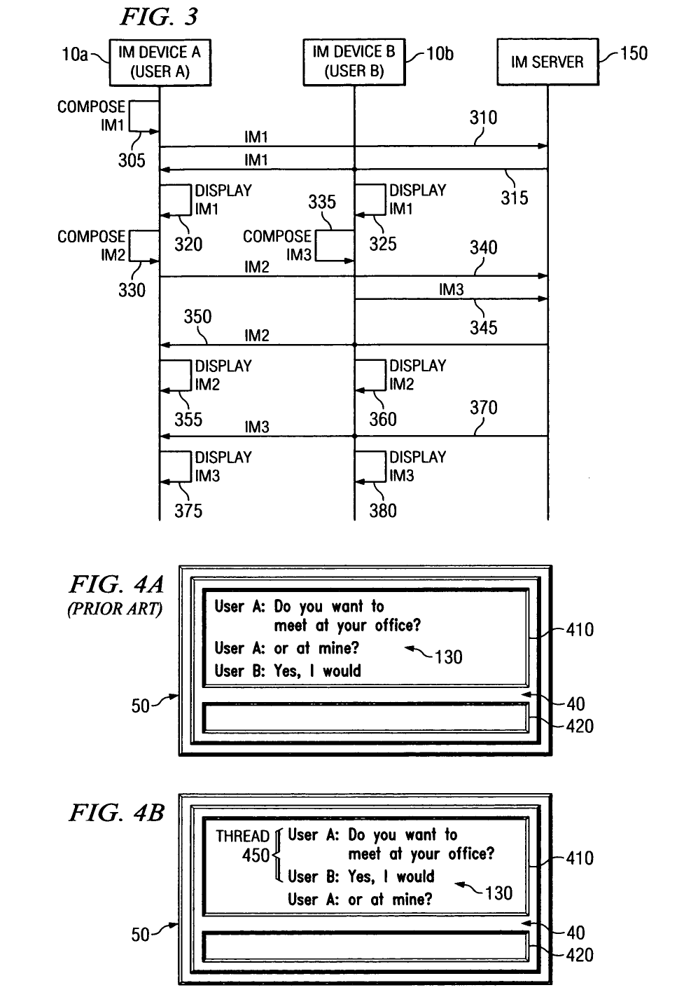

Based on the user-input, the processor 20 identifies the instant message thread associated with the responded-to instant message, and includes a thread indicator identifying the associated instant message thread within the outgoing instant message. In one embodiment, the thread indicator can identify a specific instant message in the stream of instant messages (e.g., a message number). In this embodiment, the instant message thread includes the instant message identified by the message number (identified previous instant message), and the outgoing instant message can be displayed on the receiving instant message display device so as to visually associate the outgoing instant message with the identified previous instant message. In another embodiment, the thread indicator can include a timestamp that is used by the recipient instant message device 10 to determine the instant message displayed on the display 50 of the recipient instant message device 10 immediately prior to the timestamp. In this embodiment, the instant message thread includes the instant message displayed immediately prior to the timestamp (identified previous instant message), and the outgoing instant message can be displayed on the receiving instant message display device so as to visually associate the outgoing instant message with the identified previous instant message. Additional details of the multi-threaded capability of the instant message client 35 will be discussed below in connection with FIGS. 3-10.

In an exemplary embodiment, the user interface 40 is a graphical user interface (GUI) that displays tools in the form of icons and/or text to a user of the instant message device 10 on the display 50 to enable the user to generate (compose) a text-based instant message to a message recipient and transmit that instant message to the message recipient. For example, the GUI 40 may provide a “Buddy List” to the user that indicates whether a particular message recipient is on-line and available to receive instant messages, a “Send Instant Message” or other similar button that the user can click on to initiate an instant message to an identified message recipient, a textual pop-up window within which the user can type the instant message and a transmission button (e.g., “Send”, “Enter” or other button) that instructs the instant message client 35 to send the typed instant message to the identified message recipient.

The GUI 40 interfaces with the input device 60 to receive instructions regarding message generation and transmission from the user and to provide such instructions to the instant message client 35. For example, the input device 60 may include one or more of a keyboard, mouse, stylus, touch screen, voice recognition application or other similar device.

FIG. 2 illustrates an exemplary instant messaging communication system 100 for use with embodiments of the present invention. The instant messaging communication system 100 includes instant message devices 10 for generating, transmitting and receiving instant messages 130, an instant message server 150 providing an instant message service to one or more of the instant message devices 10 and a communication network 120 for routing instant messages 130 between the instant message devices 10 and the instant message server 150.

As described above, each instant message device 10 is a user-operated physical communications device capable of sending and/or receiving electronic text-based instant messages 130 over the communications network 120. Thus, each instant message device 10 includes an instant message client 35 for generating, transmitting and receiving instant messages and a GUI 40 for displaying the sent and received instant messages on a display 50 of the instant message device 10.

The message server 150 is coupled to receive instant messages 130 generated by the instant message devices 10 via the communications network 120. In addition, the message server 150 is coupled to provide the instant messages 130 to the correct instant message devices 10 (i.e., instant message recipients) via the communications network 120. For example, in exemplary embodiments, the message server 150 is a computer network server, a telephony server (e.g., a circuit switch or end office, IP router, gateway, etc.), an e-mail server, a web server or any other networked device capable of sending and/or receiving electronic text-based instant message communications over communications network 120.

In FIG. 2, the communications network 120 represents any type of network over which media (circuit-switched or packet-switched data) may be sent. For example, the communications network 120 may include one or more of the following: the Public Switched Telephone Network (PSTN), Public Land Mobile Network (PLMN), one or more private local area networks (LANs), the Internet and/or any other type or combination of networks.

In an exemplary operation, an originating user accesses one of the instant message devices 10 and initiates the instant message client 35 on his/her instant message device 10 to generate an instant message 130 to a recipient user. The originating user enters the recipient address (e.g., e-mail address of the recipient) and a textual message stream into the instant message 130, and the instant message client 35 transmits the instant message 130 over the communications network 120. The recipient address is used by the communications network 120 to identify and locate the instant message server 150 associated with the recipient, and to route the instant message 130 to that instant message server 150.

Upon receiving the instant message 130, the instant message server 150 may perform additional processing on the instant message 130 (e.g., filtering, automatically forwarding the instant message 130 to another instant message subscriber or another instant message device associated with the recipient and/or converting the instant message into a format desired by the recipient) before providing the instant message 130 to the appropriate receiving instant message device 10 (e.g., downloading the instant message 130 via communications network 120 substantially instantly to the instant message client 35 running on the receiving instant message device 10). The instant message client 35 on the receiving instant message device 10 displays the instant message to the recipient user on the display 50 of the receiving instant message device 10 via the GUI 40.

In addition, the instant message server 150, in combination with the instant message client 35, may provide various instant messaging options to the recipient user for responding to the received instant message 130. For example, the instant message server 150 in conjunction with the instant message client 35 may enable the recipient user to generate and transmit a response to the received instant message 130, forward the instant message 130 to another subscriber or another instant message device 10 associated with the recipient or save the instant message 130 in a folder on the instant message server 150 or a local folder on the instant message device 10 associated with the recipient user.

For example, in accordance with embodiments of the present invention, the instant message client 35 can enable the recipient user to generate a response to the received instant message 130 by either clicking on the received instant message 130 on the display 50 or immediately beginning to type a response to the received instant message 130 before any other instant messages are received. Thus, the user specifically identifies to the instant message client 35 the received instant message 130 to which the response instant message is directed, and from the identified received instant message 130, the instant message client 35 determines a thread indicator identifying the instant message thread associated with the identified received instant message and includes that thread indicator in the response instant message.

FIG. 3 is a message flow diagram illustrating an exemplary two-party instant message exchange, in accordance with embodiments of the present invention. In FIG. 3, a first user (User A) is operating a first instant message device (IM Device A) 10a and a second user (User B) is operating a second instant message device (IM Device B) 10b. Both User A and User B are served by the same instant message server (IM server) 150. At 305, User A composes a first instant message (IM1) to User B on IM Device A 10a, and at 310, IM Device A 10a transmits IM1 to the IM server 150. At 315, the IM server 150 processes IM1 to determine the source address and destination address, and transmits IM1 to IM Device B 10b (based on the destination address) and back to IM Device A 10a (based on the source address). At 320 and 325, IM1 is displayed on both IM Device A 10a and IM Device B 10b.

Thereafter, at 330, User A composes a second instant message (IM2) to User B on IM Device A 10a. Around the same time, at 335, User B composes a third instant message (IM3) to User A on IM Device B 10b. User A's instant message (IM2) is transmitted to the IM server 150 before User B's instant message (IM3), as can be seen at 340 and 345. Therefore, at 350, the IM server 150 transmits IM2 to both IM Device B 10b and IM Device A 10a, where IM2 is displayed at 355 and 360, and then at 370, the IM server 150 transmits IM3 to both IM Device B 10b and IM Device A 10a, where IM3 is displayed at 375 and 380.

Turning now to FIGS. 4A and 4B, FIG. 4A illustrates an exemplary prior art display of the instant message exchange of FIG. 3, whereas FIG. 4B illustrates an exemplary display of the instant message exchange of FIG. 3 in accordance with embodiments of the present invention. The display 50 shown in FIGS. 4A and 4B includes a graphical user interface (GUI) 40 within with a text display window 410 and a text entry window 420 are displayed. The text display window 410 displays the stream of instant messages 130 during the instant message communication session, while the text entry window 420 provides an interface for the user to type a new instant message.

As can be seen in FIG. 4A, each instant message 130 is displayed in the text display window 410 in chronological order of receipt. Therefore, User A's first instant message (IM1) “Do you want to meet at your office?” is displayed first, followed by User A's second instant message (IM2) “or at mine?,” followed by User B's third instant message (IM3) “Yes, I would.” Displaying the instant messages 130 in the order received, as shown in FIG. 4A, may result in an ambiguous instant message exchange. For example, in FIG. 4A, it is unclear whether User B is responding to the first instant message (IM1) or the second instant message (IM2).

However, looking at the instant message exchange displayed in FIG. 4B, the confusion is removed by associating each instant message 130 with a particular instant message thread 450. Thus, in FIG. 4B, User A's first instant message (IM1) “Do you want to meet at your office?” is displayed first, followed by User B's third instant message (IM3) “Yes, I would,” and then followed by User A's second instant message (IM2) “or at mine?”. By displaying instant messages in order of instant message thread, as in FIG. 4B, the context of the instant message exchange is clear.

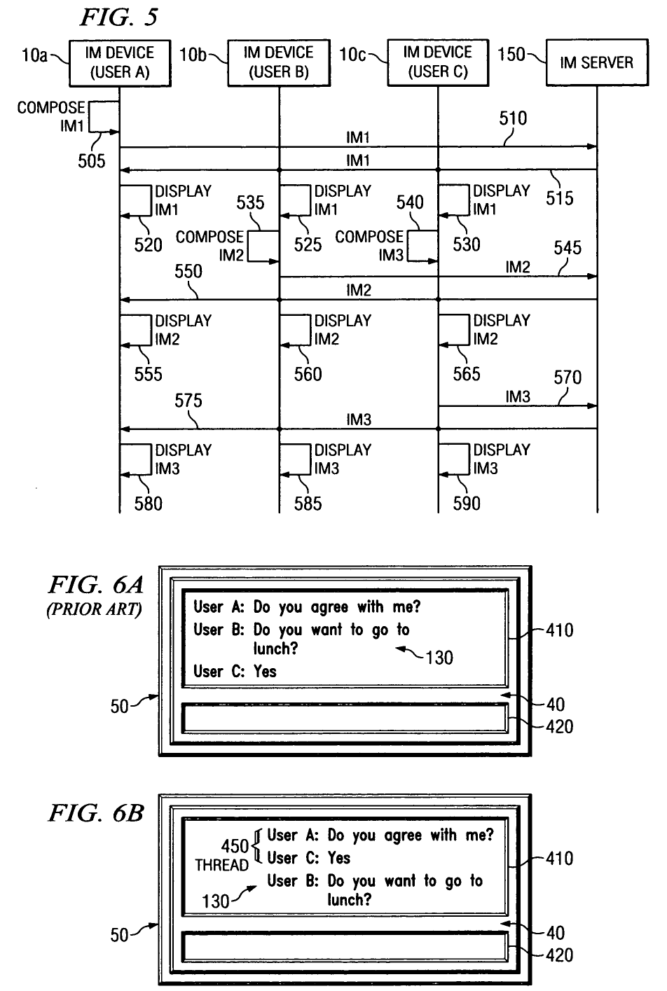

FIG. 5 is another message flow diagram illustrating an exemplary multi-party instant message exchange, in accordance with embodiments of the present invention. In FIG. 5, a first user (User A) is operating a first instant message device (IM Device A) 10a, a second user (User B) is operating a second instant message device (IM Device B) 10b and a third user (User C) is operating a third instant message device (IM Device C) 10c. User A, User B and User C are all served by the same instant message server (IM server) 150. At 505, User A composes a first instant message (IM1) to User B and User C on IM Device A 10a, and at 510, IM Device A 10a transmits IM1 to the IM server 150. At 515, the IM server 150 processes IM1 to determine the source address and destination addresses, and transmits IM1 to both IM Device C 10c and IM Device B 10b (based on the destination addresses) and back to IM Device A 10a (based on the source address). At 520, 525 and 530, IM1 is displayed on each of IM Device A 10a, IM Device B 10b and IM Device C 10c.

Thereafter, at 535, User B composes a second instant message (IM2) to User A and User C on IM Device B 10b. Around the same time, at 540, User C composes a third instant message (IM3) to User A and User B on IM Device C 10c. User B's instant message (IM2) is transmitted to the IM server 150 before User C's instant message (IM3), as can be seen at 545. Therefore, at 550, the IM server 150 transmits IM2 to IM Device C 10c, IM Device B 10b and IM Device A 10a, where IM2 is displayed at 555, 560 and 565. Then, at 570, User C's instant message (IM3) is transmitted to the IM server 150, and at 575, the IM server 150 transmits IM3 to IM Device C 10c, IM Device B 10b and IM Device A 10a, where IM3 is displayed at 580, 585 and 590.

Turning now to FIGS. 6A and 6B, FIG. 6A illustrates an exemplary prior art display of the instant message exchange of FIG. 5, whereas FIG. 6B illustrates an exemplary display of the instant message exchange of FIG. 5 in accordance with embodiments of the present invention. As can be seen in FIG. 6A, each instant message 130 is again displayed in the text display window 410 in chronological order of receipt. Therefore, User A's first instant message (IM1) “Do you agree with me?” is displayed first, followed by User B's second instant message (IM2) “Do you want to go to lunch?,” followed by User C's third instant message (IM3) “Yes.” The instant message exchange displayed as in FIG. 6A is ambiguous since it is unclear whether User C is responding to the first instant message (IM1) or the second instant message (IM2).

By contrast, the instant message exchange is displayed in FIG. 6B in order of instant message thread 450. Thus, in FIG. 6B, User A's first instant message (IM1) “Do you agree with me?” is displayed first, followed by User C's third instant message (IM3) “Yes,” and then followed by User B's second instant message (IM2) “Do you want to go to lunch?”. By displaying instant messages in order of instant message thread, as in FIG. 6B, the context of the instant message exchange is clear.

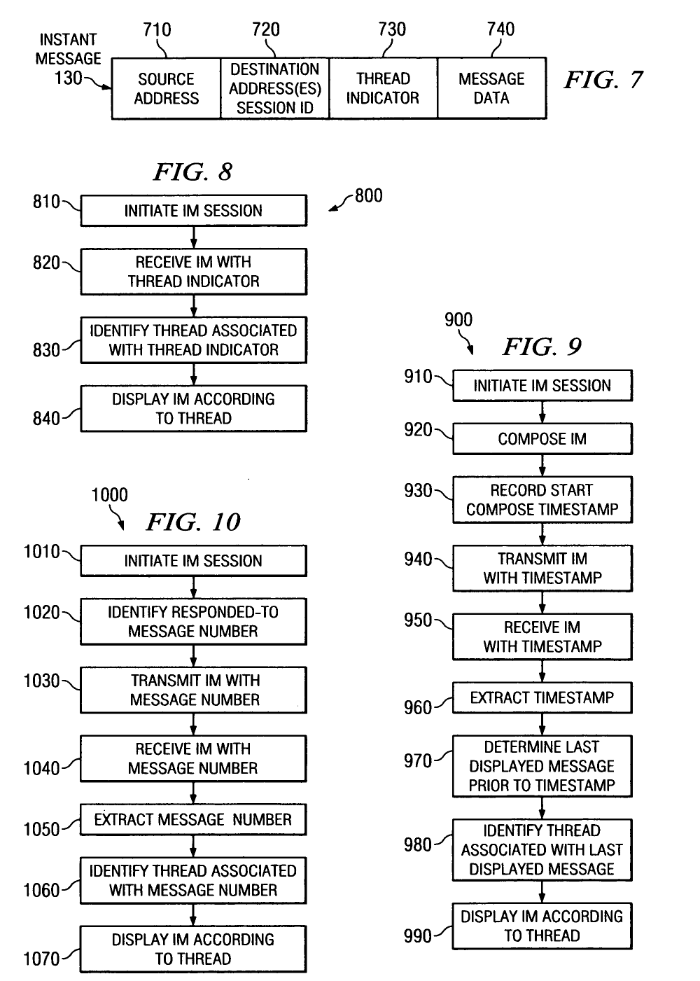

FIG. 7 illustrates an exemplary format of an instant message, in accordance with embodiments of the present invention. As shown, the exemplary instant message 130 includes a source address field 710, a destination address(es)/Session ID field 720, a thread indicator 730 and a message field 740. The source address field 710 includes the address (e.g., IP address or e-mail address) of the user that originated the instant message and the destination address(es)/Session ID field 720 includes the addresses (e.g., IP address or e-mail address) of each message recipient, or in the alternative, includes an identifier for the instant message communication session, which is used to determine the destination address(es) for the instant message 130. The message field 740 includes the text-based message data typed or otherwise entered by the message originating user for the instant message 130.

The thread indicator field 730 includes a thread indicator identifying a particular instant message thread associated with the instant message 130. For example, in one embodiment, the thread indicator can include a message number that identifies a specific previous instant message in a stream of instant messages, and this message number can be used to determine the instant message thread associated with the instant message 130. For example, the instant message thread may be identified as including the previous instant message identified by the message number. In another embodiment, the thread indicator can include a timestamp that identifies the specific time that composure of the instant message 130 began, and this timestamp can be used to determine the instant message thread associated with the instant message. For example, the instant message thread may be identified as including the instant message immediately prior to the timestamp.

FIG. 8 is a flowchart illustrating an exemplary process 800 for facilitating multi-threaded instant message streams, in accordance with embodiments of the present invention. At block 810, an instant message communication session is initiated between two or more users. Thereafter, at block 820, a current instant message is received during the instant message communication session by one of the users. The current instant message includes a thread indicator that is used at block 830 to identify an instant message thread associated with the current instant message. The instant message thread identifies at least one instant message in a stream of instant messages transmitted during the instant message communication session. Finally, at block 840, the current instant message is displayed such that the current instant message is visually associated with the identified instant message thread.

FIG. 9 is a flowchart illustrating another exemplary process 900 for facilitating multi-threaded instant message streams, in accordance with embodiments of the present invention. At block 910, an instant message communication session is initiated between two or more users during which instant messages are transmitted between the users and viewed by the users as a stream of instant messages. Thereafter, at block 920, one of the users begins composing a current instant message. Upon detection that a current instant message is being composed, at block 930, the composure start time of the current instant message is recorded as a timestamp. After completing the current instant message, at block 940, the current instant message is transmitted with the timestamp.

At block 950, the current instant message with the timestamp is received during the instant message communication session by one of the users. The timestamp is extracted from the current instant message at block 960, and at block 970, the timestamp is used to determine the last displayed message prior to the timestamp. For example, in one embodiment, the timestamp (start composure time) is compared with the display times (or receive times) of displayed instant messages to identify the displayed instant message with the display time (or receive time) immediately prior to the value of the timestamp. From the identified last displayed message, at block 980, an instant message thread associated with the current instant message is identified (e.g., the instant message thread including the identified last displayed message). Finally, at block 990, the current instant message is displayed such that the current instant message is visually associated with the identified instant message thread.

FIG. 10 is a flowchart illustrating yet another exemplary process 1000 for facilitating multi-threaded instant message streams, in accordance with embodiments of the present invention. At block 1010, an instant message communication session is initiated between two or more users. During the instant message communication session, instant messages are transmitted between the users and viewed by the users as a stream of instant messages. In addition, each of the instant messages in the stream of instant messages has a respective message identifier associated therewith.

Thereafter, at block 1020, one of the users identifies an instant message by message number to which that user would like to generate a response. Upon composing the response instant message, at block 1030, the response instant message is transmitted with the message number of the message to which the response instant message is directed. At block 1040, the response instant message with the message number is received during the instant message communication session by one of the users. The message number is extracted from the response instant message at block 1050, and at block 1060, the message number is used to identify an instant message thread associated with the message number (i.e., the instant message to which the response instant message is directed). Finally, at block 1070, the response instant message is displayed such that the response instant message is visually associated with the identified instant message thread.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

I claim:

1. An instant message device, comprising:
an instant message client capable of managing multiple instant message threads, each of said instant message threads identifying at least one instant message in a stream of instant messages transmitted during an instant message communication session between a first user operating said instant message device and at least one additional user;
a processor for executing said instant message client to initiate said instant message communication session and process a current instant message received from said at least one additional user during said instant message communication session, said current instant message including a thread indicator identifying one of said instant message threads as an identified instant message thread; and
a display coupled to said processor for displaying said stream of instant messages such that said current instant message is visually associated with said identified instant message thread.

2. The device of claim 1, further comprising:
a graphical user interface coupled between said processor and said display for displaying said instant message on said display.

3. The device of claim 2, wherein said graphical user interface is further operable to enable said first user to generate a response instant message in response to a select one of said instant messages in said stream of instant messages, and wherein said processor is operable to identify a select one of said instant message threads associated with said select instant message and to include an additional thread indicator identifying said select instant message thread within said response instant message.

4. The device of claim 3, further comprising:
at least one input device coupled to said graphical user interface and manipulated by said first user to identify said select instant message and to compose said response instant message in response to said select instant message.

5. The device of claim 1, wherein each of said instant messages in said stream of instant messages has a respective message identifier associated therewith and said thread indicator includes one of said message identifiers.

6. The device of claim 1, wherein said thread indicator includes a timestamp, and wherein said processor is operable to identify one of said instant messages displayed on said display immediately prior to said timestamp as said identified instant message thread.

7. The device of claim 6, wherein said timestamp indicates a start time at which said at least one additional user commenced composing said current instant message.

8. The device of claim 1, wherein said display displays said instant messages in said stream of instant messages in order of instant message thread.

9. The device of claim 1, wherein said instant message communication session includes multiple instant message communication sessions, each associated with said first user and at least one other user.

10. An instant messaging communication system, comprising:
an instant message device including:
an instant message client capable of managing multiple instant message threads, each of said instant message threads identifying at least one instant message in a stream of instant messages transmitted during an instant message communication session, each of said instant message threads being identified by a respective thread indicator included in said instant messages, and
a display for displaying said stream of instant messages to visually associate said instant messages with said respective instant message threads;
an instant message server associated with said instant message device for transmitting and receiving said instant messages to and from said instant message device; and
a communication network over which said instant messages are transmitted between said instant message device and said instant message server.

11. The system of claim 10, wherein said instant message client is further capable of receiving said instant messages in said stream of instant messages as received instant messages, identifying said respective instant message thread associated with said respective thread indicator included in each of said received instant messages and displaying said received instant messages on said display in order of said instant message threads.

12. The system of claim 10, wherein said instant message client is further capable of enabling a user to generate a response instant message in response to a select one of said instant messages in said stream of instant messages, identifying a select one of said instant message threads associated with said select instant message and including said thread indicator identifying said select instant message thread within said response instant message.

13. The system of claim 10, further comprising:
at least one additional instant message device involved in said instant message communication session and coupled to said communication network, each said additional instant message device including:
a respective instant message client capable of receiving said instant messages in said stream of instant messages as received instant messages, and for each of said received instant messages, identifying said instant message thread associated with said thread indicator included in said received instant message, and
a respective display for displaying said received instant messages in order of said instant message threads.

14. The system of claim 10, wherein each of said instant messages in said stream of instant messages has a respective message identifier associated therewith and said thread indicator includes one of said message identifiers.

15. The system of claim 10, wherein said thread indicator of a select one of said instant messages includes a timestamp, and wherein said instant message client is operable to identify one of said instant messages displayed on said display immediately prior to said timestamp as said instant message thread associated with said select instant message.

16. The system of claim 15, wherein said timestamp indicates a start time at which a user commenced composing said select instant message.

17. A method for facilitating multi-threaded instant messaging, comprising the steps of:
initiating an instant message communication session;
receiving a current instant message during said instant message communication session, said current instant message including a thread indicator;
identifying an instant message thread associated with said current instant message from said thread indicator, said instant message thread identifying at least one instant message in a stream of instant messages transmitted during said instant message communication session; and
displaying said current instant message such that said current instant message is visually associated with said instant message thread.

18. The method of claim 17, further comprising the steps of:
generating a response instant message in response to a select one of said instant messages in said stream of instant messages;
identifying said instant message thread associated with said select instant message; and
including said thread indicator identifying said instant message thread associated with said select instant message within said response instant message.

19. The method of claim 17, wherein each of said instant messages in said stream of instant messages has a respective message identifier associated therewith and said thread indicator includes one of said message identifiers.

20. The method of claim 17, wherein said thread indicator includes a timestamp, and wherein said identifying said instant message thread associated with said current instant message further includes:
identifying one of said instant messages displayed immediately prior to said timestamp as said instant message thread.

21. The method of claim 20, wherein said timestamp indicates a start time at which a user commenced composing said current instant message.

22. The method of claim 17, further comprising the step of:
managing multiple instant message threads, each of said instant message threads identifying at least one of said instant messages in said stream of instant messages transmitted during said instant message communication session; and
displaying said instant messages in said stream of instant messages in order of said respective instant message threads.
